(19) United States
(12) Patent Application Publication
(10) Pub. No.: US 2022/0264889 A1
(43) Pub. Date: Aug. 25, 2022

(54) BIOCIDAL DISPERSIONS FOR COATING COMPOSITIONS

(71) Applicant: Corning Incorporated, Corning, NY (US)

(72) Inventors: Bavani Balakrisnan, Corning, NY (US); David Michael Fasano, Lansdale, PA (US); Bryan Patrick Livengood, Nicholasville, KY (US); Joseph Martin Rokowski, Barto, PA (US)

(21) Appl. No.: 17/631,980

(22) PCT Filed: Aug. 4, 2020
(86) PCT No.: PCT/US2020/044835

§ 371 Date: Feb. 1, 2022

Related U.S. Application Data
(60) Provisional application No. 62/883,788, filed on Aug. 7, 2019.

(51) Int. Cl. A01N 59/20; A01N 25/04; A01N 25/24; A01P 1/00

(52) U.S. Cl. CPC A01N 59/20; A01N 25/04; A01N 25/24; A01P 1/00

(57) ABSTRACT

According to various examples of the present disclosure, a biocidal dispersion includes one or more inorganic glass comprising copper particles. The biocidal dispersion further includes a dispersant, a thickener, or a mixture thereof. The inorganic glass comprising copper is homogenously distributed about the biocidal dispersion and is in a range of from about 3 wt % to about 88 wt % of the biocidal dispersion.

### CROSS-REFERENCE TO RELATED APPLICATIONS

This application claims the benefit of priority under 35 U.S.C. § 119 of U.S. Provisional Application No. 62/883,788 filed Aug. 7, 2019, the content of which is incorporated herein by reference in its entirety.

### BACKGROUND

Coatings or compositions such as paint can be applied on a substrate or surface or stored in a container. Over time, the coating or composition can be exposed to a number of undesired contaminants such as bacteria, viruses, mildew, mold, fungi, algae and the like. Exposure to these contaminants can render the coating or composition visually unattractive or unsuitable for a particular purpose or present a health hazard. It can therefore be desirable to mitigate the ability of the undesired contaminants to thrive once in contact with a coating or composition.

### SUMMARY OF THE DISCLOSURE

According to various examples of the present disclosure, a biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion.

According to various examples of the present disclosure, a coating composition includes a biocidal dispersion. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The coating further includes one or more emulsion polymers, a pH modifier, and an organic or aqueous solvent.

According to various examples of the present disclosure, a method of making a biocidal dispersion is described. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The method includes combining one or more inorganic glass comprising copper particles and dispersant, thickener, or a mixture thereof to form a dispersion precursor. The method further includes mixing the dispersion precursor to form the biocidal dispersion.

According to various examples of the present disclosure, a method of making a coating composition is described. The coating composition includes a biocidal dispersion. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The coating composition further includes one or more emulsion polymers, a pH modifier, and an organic or aqueous solvent. The method includes combining the biocidal dispersion with one or more emulsion polymers, a pH modifier, and an organic solvent or aqueous solvent.

According to various examples of the present disclosure, a dried product is described. The dried product is a dried product of a coating composition. The coating composition includes a biocidal dispersion. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The coating composition further includes one or more emulsion polymers, a pH modifier, and an organic or aqueous solvent.

According to various examples of the present disclosure an assembly includes a substrate and a coating composition distributed on the substrate. The coating composition includes a biocidal dispersion. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The coating composition further includes one or more emulsion polymers, a pH modifier, and an organic or aqueous solvent.

According to various examples of the present disclosure a method of making an assembly includes applying a coating composition to at least a portion of a substrate. The coating composition includes a biocidal dispersion. The biocidal dispersion includes one or more inorganic glass comprising copper particles. The biocidal dispersion further includes a dispersant, thickener, or a mixture thereof. The inorganic glass comprising copper is homogenously distributed about the biocidal dispersion and is in a range of from about 3 wt % to about 88 wt % of the biocidal dispersion. The coating composition further includes one or more emulsion polymers, a pH modifier, and an organic or aqueous solvent. The method includes combining the biocidal dispersion with one or more emulsion polymers, a pH modifier, and an organic solvent or aqueous solvent. The method further includes drying the composition thereon.

### DETAILED DESCRIPTION

Reference will now be made in detail to certain examples of the disclosed subject matter. While the disclosed subject matter will be described in conjunction with the enumerated claims, it will be understood that the exemplified subject matter is not intended to limit the claims to the disclosed subject matter.

Various examples of the present disclosure relate to a biocidal dispersion. The biocidal dispersion can be used as an additive that can be incorporated into a coating composition to add biocidal activity to the coating composition. The biocidal dispersions described herein can include one or more copper particles components homogenously distributed in a dispersant, thickener, or a mixture thereof. For example, the copper particles components can include inorganic glass comprising copper particles, copper oxide comprising copper particles, copper metal comprising copper particles, or combinations thereof. A median size of the one or more inorganic glass comprising copper particles can be in a range of from about 1 μm to about 15 μm, about 3 μm to about 8 μm, about 4 μm to about 6 μm, less than, equal to, or greater than about 1 μm, 2, 3, 4, 5, 6, 7, 8, 9, 10, 11, 12, 13, 14, or about 15 μm. The median size can be determined by analyzing the major dimension of the individual inorganic glass comprising copper particles. The major dimension, on an individual basis, can be a measurement of the diameter, width, or length of the individual inorganic glass comprising copper particles.

The copper particles components can be present in a range of from about 3 wt % to about 88 wt % of the biocidal dispersion, about 10 wt % to about 87 wt %, about 42 wt % to about 85 wt %, less than, equal to, or greater than about 3 wt %, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, or about 88 wt %.

In embodiments including inorganic glass comprising copper particles, the inorganic glass portion of the individual inorganic glass comprising copper particle component can include any suitable material such as SiO₂, Al₂O₃, CaO, MgO, P₂O₅, B₂O₃, K₂O, ZnO, Fe₂O₃, nanoparticles thereof, or a mixture thereof. The copper of the inorganic glass comprising copper particles can be present in an individual inorganic glass comprising copper particle in any suitable amount. For example, the copper can be present in a range of from about 5 wt % to about 80 wt % of the individual inorganic glass comprising copper particle, about 10 wt % to about 70 wt %, about 25 wt % to about 35 wt %, about 40 wt % to about 60 wt %, about 45 wt % to about 55 wt %, less than, equal to, or greater than about 5 wt %, 10, 15, 20, 25, 30, 35, 40, 45, 50, 55, 60, 65, 70, 75, or about 80 wt %. In each inorganic glass comprising copper particle, the copper portion can independently include a Cu metal, Cu⁺, Cu²⁺, or a combination of Cu⁺ and Cu²⁺. The copper can be non-complexed or can have a ligand bonded thereto to form a complex. Although the inorganic glass comprising copper particle is effective as a biocidal agent, a potential drawback is that the copper offers numerous opportunities for ligands to attach thereto, resulting in complexes that can alter the color of a coating composition to which it is ultimately incorporated. However, it is possible to pair the inorganic glass comprising copper particles with various additional additives in order to limit the extent to which the copper is complexed and therefore the color of the coating composition is altered from a standard.

For example, in a coating composition to which the biocidal dispersion is incorporated, it is possible to achieve a CIEL*a*b* delta E* between the observed color and a standard (e.g., a dispersion or coating including the same constituents, but are free of or include a different amount of the glass comprising copper) of less than about 15, less than about 14, less than about 13, less than about 12, less than about 11, less than about 10, less than about 9, less than about 8, less than about 7, less than about 6, less than about 5, less than about 4, less than about 3, less than about 2, less than about 1, in a range of from about 1 to about 15, about 2 to about 13, about 5 to about 10, about 3 to about 8, about 4 to about 7, about 5 to about 6, less than, equal to, or greater than about 1, 2, 3, 4, 5, 6, 7, 8, 9, 10, 11, 12, 13, 14, 15, 16, 17, 18, 19, 20, 21, 22, 23, 24, or about 25. As understood, the CIEL*a*b* color scale is a scale for determining a color. Using this test, the difference (e.g., a delta E*) in color between a standard and observed color can be measured. In this manner, the extent to which the desired color of a coating is altered by the components therein can be measured.

In operation, the copper from the biocidal dispersion can be released into the coating composition to interact with and kill unwanted biological contaminants such as microbes in the composition. Examples of microbes that the copper can kill include Staphylococcus aureus, Enterobacter aerogenes, Pseudomonas aeruginosa, Methicillin Resistant, E. coli, Enterobacter cloacae, Acinetobacter baumannii, Enterococcus faecalis, Klebsiella pneumoniae, Klebsiella aerogenes, Staphylococcus aureus, and mixtures thereof. Examples of viruses that the copper can kill include Influenza H1N1, Adenovirus 5, and Norovirus. An example of a fungi the copper can kill includes Candida auris. The effectiveness of the dispersion or coating composition as a biocidal coating can be measured as a function of the coating composition's log reduction. The coating composition's log reduction value can be relevant to its ability to kill biological organisms to which it is exposed, but can also allow the inorganic glass comprising copper to act as a preservative for the coating composition during storage (e.g., in a container such as, but not limited to a tank, can, bucket, drum, bottle, or tube).

According to various examples, a log reduction of the biocidal dispersion, or of the coating to which it is incorporated, can be at least about 2, at least about 3, at least about 4, at least about 5, at least about 6, at least about 7, at least about 8, at least about 9, at least about 10, in a range of from about 1 to about 10, about 3 to about 7, about 4 to about 6, or less than, equal to, or greater than about 1, 2, 3, 4, 5, 6, 7, 8, 9, or about 10. The log reduction value can be measured according to the ASTM D2574-16 (2016) Standard test method for resistance of emulsion paints in the container to attack by microorganisms. An example of an advantage to using the inorganic glass comprising copper components described herein is that the copper is less corrosive, and toxic, than many organic biocidal compounds that are included in corresponding coating compositions.

In the biocidal dispersion, the individual copper particles components are dispersed with a dispersant, thickener, or a mixture thereof, which is at least partially soluble in the carrier liquid. Suitable dispersants include those that are able to facilitate a homogenous distribution of the copper components. For example, suitable dispersants or thickeners can help to mitigate the possibility of a substantial amount of the copper comprising glass particles falling out of suspension as a sediment. The ability of the dispersant or thickener to help prevent sedimentation can be determined, for example, by a test such as ASTM D5590 or ASTM D2574. Thus, the biocidal dispersion is considered a stable dispersion. According to various examples, it can be possible for the biocidal dispersion or coating composition to which the dispersion is incorporated to be free of a sediment of the copper particles components for a time period in a range of from about 1 day to about 365 days, about 5 days to about 90 days, less than equal to or greater than about 1 day, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, or about 365 days. While not so limited, examples of suitable organic dispersants can include an acrylic acid containing copolymer, a urethane, a carboxylate containing oligomer, an amine containing oligomer, a phosphate containing oligomer, a sulfonate containing oligomer, an anhydride containing oligomer, or a mixture thereof. Examples of suitable thickeners that can be used include celluloses. Examples of celluloses can include hydrophobically modified celluloses. More specific, though non-limiting, examples of suitable celluloses can include hydroxyethyl cellulose, methyl cellulose, carboxymethyl cellulose, or a mixture thereof. In some examples, the dispersant can include any of the constituents mentioned herein as well as water. For example, a dispersant can include a carboxylate containing oligomer, an amine containing oligomer, a phosphate containing oligomer, a sulfonate containing oligomer, an anhydride containing oligomer, or a mixture thereof that are dispersed in water.

As stated herein the biocidal dispersion can be an individual component that can be added to a coating composition in order to effectively deliver the copper particles components. According to various examples, a non-limiting benefit to adding the copper particles components, as part of a biocidal dispersion, to a coating composition is that the distribution of the copper particles components in the coating composition can be improved relative to mixing the copper particles components alone into the coating composition directly. For example, if the coating composition itself is particularly thick or viscous, direct addition of the copper particles components can take quite a bit of effort to mix into coating composition. This can be because the copper particles components can be added as an aggregate that will require dispersion into the coating composition. By contrast, if the copper particles components are effectively pre-dispersed, by virtue of being a component of the biocidal dispersion, it can be easier or quicker to disperse the copper particles components in the coating composition. This can be because the copper comprising glass particles are already dispersed upon contact with the coating composition. Additionally, according to some examples, including the copper particles components as a pre-dispersed mixture can lead to the copper particles components being dispersed in the coating composition more quickly.

In some examples, the biocidal dispersion can include only the copper particles components and a dispersant, a thickener, or a mixture thereof. However, in further examples, the biocidal dispersion can include additional components. These additional components can be components chosen to convey certain desirable properties to the biocidal dispersion. In some examples, the additional components added to the biocidal dispersions can be components that are also present in a coating composition to which the biocidal dispersion is mixed. Examples of suitable additional components can include a cosolvent, a pH modifier, a surfactant, a defoamer or air release agent, a rheological pigment, a stabilizer, a rheology modifier, or a mixture thereof. Examples of suitable cosolvents can include any of the aqueous or organic solvents described herein and can additionally include isopropanol, xylene, butyl acetate, or a mixture thereof.

In some embodiments, the biocidal dispersion is free or substantially free of resins or binders (e.g., conventional resins or binders used in paint or coating compositions). For example, the biocidal dispersion comprises less than 5%, less than 1%, less than 0.5%, or less than 0.1% by weight of the resins or binders. Examples of such resins or binders may include, without limitation, one or more of phenolic resin, urea formaldehyde resin, epoxy resin, unsaturated polyester, polyurethane resin, silicone resin, alkyd resin, acrylic resin (e.g., acrylic ester), epoxy resin, polyethylene (PE), polyvinyl chloride (PVC), polystyrene (PS), polyvinyl acetate (PVAC), polypropylene (PP), polymethacrylic acid (PMMA), acrylonitrile butadiene styrene (ABS), copolymers thereof, or combinations thereof.

A pH modifier can be used to maintain a pH of the biocidal dispersion to be in a range of from about 6 to about 9.5, about 7.5 to about 9, about 7.5 to about 8.5, less than, equal to, or greater than about 6, 6.5, 7, 7.5, 8, 8.5, 9, or about 9.5. Maintaining a pH in this range can be helpful to influence the reactivity of copper ions with other materials in the biocidal dispersion or in the coating composition. Ultimately, this can affect the color of the coating composition as a whole. Moreover, the pH of the biocidal dispersion or coating composition can impact the shelf life and viscosity of the biocidal dispersion or coating composition.

The pH modifier or modifiers can independently have a pKa in a range of from about 4.7 to about 14, about 5 to about 9.5, about 6 to about 9.5, about 7 to about 9.5, less than, equal to, or greater than about 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, or about 14. The pH modifier can be present in the biocidal dispersion in a range of from about 0.1 wt % to about 5 wt % of the biocidal dispersion, about 0.5 wt % to about 2 wt %, about 1 wt % to about 1.5 wt %, less than, equal to, or greater than about 0.1 wt %, 0.5, 1, 1.5, 2, 2.5, 3, 3.5, 4, 4.5, or about 5 wt %.

Specific non-limiting examples of suitable pH modifiers of buffer solutions include those selected from the group of Group (I) hydroxides; Group (II) hydroxides; and organic amines. More specific non-limiting examples of suitable pH modifiers include those selected from metal hydroxides, ammonium hydroxide, and amines, wherein the amines are amines of the formula NH₂R, wherein R is selected from the group consisting of H, OR′ or —R′—OH, wherein R′ is selected from the group consisting of —H, alkane, and alkylene. Specific further non-limiting examples of suitable pH modifiers include potassium hydroxide, sodium hydroxide, 2-amino-2-methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine. Specific further non-limiting examples of suitable pH modifiers include a mixture of at least one of potassium hydroxide and sodium hydroxide and at least one of 2-amino-2methyl-1-propanol and ammonia, in which at least one of potassium hydroxide and sodium hydroxide, or a mixture thereof are the major component of the pH modifier mixture. In some examples, it can be desirable to avoid a pH modifier that includes ammonia or amines. This is because ammonia and amines can engage in undesirable reactions with the copper and create undesirable colors in the biocidal dispersion.

A defoamer or air release agent can be used to help the biocidal dispersion to avoid forming or stabilizing air bubbles. In some examples, air bubbles can be damaging because air bubbles can cause undesirable oxidation of the copper in the wet state. Air bubbles that are in turn transmitted from the biocidal dispersion to the coating composition can cause defects in the resulting film that is ultimately formed from the coating composition. The defoamer or air release agent can include mineral oil, silicone, siloxane, phosphate, fatty alcohol, fatty acids or esters, polyethylene glycol or polyacrylates. According to further examples, the defoamer air release agent can be free of a silicone. It can be beneficial for the defoamer or air release agent to be free of a silicone because silicones may unfavorably alter the distribution of copper in the inorganic glass comprising copper component. The defoamer or air release agent can be in a range of from about 0.5 wt % to about 40 wt % of the biocidal dispersion, about 1 wt % to about 10 wt %, less than, equal to, or greater than about 0/5 wt %, 1, 5, 10, 15, 20, 2,5 30, 35, or about 40 wt %.

The biocidal dispersion can further include a rheological pigment such as a clay component such as attapulgite, laponite, bentonite, or a mixture thereof. Other examples of a rheological pigment can include a fumed silica. The rheological pigment can be in a range of from about 0.5 wt % to about 40 wt % of the biocidal dispersion, about 1 wt % to about 10 wt %, less than, equal to, or greater than about 0.5 wt %, 1, 5, 10, 15, 20, 25, 30, 35, or about 40 wt %. In some examples, the rheological pigment can be part of a rheology modifier or thickener component in the biocidal dispersion. Where present, the rheology modifier can be in a range of from about 0.1 wt % to about 5 wt % of the coating composition, about 0.5 wt % to about 2 wt %, about 0.7 wt % to about 1.5 wt %, about 1 wt % to about 1.25 wt %, less than, equal to, or greater than about 0.1 wt %, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. Examples of suitable rheological modifiers include a thickener comprising any of the rheological pigments described herein, hydroxyethyl cellulose, methyl cellulose, carboxymethyl cellulose, hydroxyethylcellulose, an alkali swellable emulsion, a hydrophobically modified ethoxylated urethane, hydrophobically modified analogues, natural or synthetic gums thereof, or a mixture thereof.

As stated herein, the rheology modifier can control a viscosity of the biocidal dispersion. According to various examples, the viscosity of the biocidal dispersion can be controlled to be in a range of from about 70 KU to about 130 KU, about 75 KU to about 120 KU, about 80 KU to about 115 KU, about 90 KU to about 110 KU, about 95 KU to about 105 KU, less than, equal to, or greater than about 70 KU, 75, 80, 85, 90, 95, 100, 105, 110, 115, 120, 125, or about 130 KU. The viscosity can be measured using any suitable instrument such as a Brookfield KU-2 viscometer. Other rheological properties of the biocidal dispersion that can be controlled can include the ability for the biocidal dispersion to be resistant to settling and syneresis during storage.

The biocidal dispersion can further include a stabilizer. The stabilizer can include a component such as an organophosphate, an ammonium phosphate, a potassium tripolyphosphate, or a mixture thereof. The stabilizer can be in a range of from about 0.5 wt % to about 20 wt % of the biocidal dispersion, about 2 wt % to about 10 wt %, less than, equal to, or greater than about 0.5 wt %, 1, 2, 3, 4, 5, 6, 7, 8, 9, 10, 11, 12, 13, 14, 15, 16, 17, 18, 19, or about 20 wt %.

The biocidal dispersion can be easily prepared according to various methods. For example, any of the components described herein can be combined into a biocidal dispersion precursor. The precursor can be mixed for an amount of time to form the biocidal dispersion. The biocidal dispersion can be mixed at any temperature including at about room temperature (e.g., 25° C.). After the biocidal dispersion is prepared, it can be incorporated into a coating composition.

Once the biocidal dispersion is incorporated into the coating composition, the concentration of the copper particles components (e.g., the glass comprising copper component) can be in a range of from about 0.01 wt % to about 15 wt % of the coating composition, about 2 wt % to about 8 wt % about 0.1 wt % to about 2 wt %, about 0.5 wt % to about 1 wt %, less than, equal to, or greater than about 0.01 wt %, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 11.2, 11.4, 11.6, 11.8, 12, 12.2, 12.4, 12.6, 12.8, 13, 13.2, 13.4, 13.6, 13.8, 14, 14.2, 14.4, 14.6, 14.8, or about 15 wt %.

Additional components of the coating composition can include any of the additional components mentioned herein with respect to the biocidal dispersion such as the cosolvent, the dispersant, the thickener, the pH modifier, the surfactant, the defoamer or air release agent, the rheological pigment, the stabilizer, the rheology modifier, or mixtures thereof. These additional components can be present in the coating composition in a concentration range substantially in-line with those described herein with respect to the biocidal dispersion. In some examples, the coating composition can include any one of or mixtures of the additional components found in the biocidal coating prior to being mixed with the biocidal dispersion. In these examples, any of the additional components that are found in coating composition can be considered a “second” version of the additional component of the biocidal dispersion. For example, the coating composition can include a second cosolvent, a second pH modifier, a second surfactant, a second defoamer or air release agent, a second rheological pigment, a second stabilizer, a second rheology modifier, or mixtures thereof. Where present, the second cosolvent, the second pH modifier, the second surfactant, the second defoamer or air release agent, the second rheological pigment, the second stabilizer, or the second rheology modifier can be the same material as their counterpart in the biocidal dispersion or it can be a different material.

The coating composition can include a latex polymer formed or produced by emulsion polymerization, otherwise referred to as one or more emulsion polymers. According to various further examples, polymers can also include those made by a solution process and then inverted or dispersed into water. Further examples of polymers can include non-aqueous dispersions. The one or more emulsion polymers can independently have a redox potential in a range of from about −200 mV to about 200 mV, about −175 mV to about 175 mV, about −150 mV to about 150 mV, about −125 mV to about 125 mV, about −100 mV to about 100 mV, about −75 mV to about 75 mV, about −50 mV to about 50 mV, about −40 mV to about 40 mV, about −30 mV to about 30 mV, about −25 mV to about 25 mV, about −20 mV to about 20 mV, about 15 mV to about 15 mV, about −9 mV to about 9 mV, about −8 mV to about 8 mV, about −7 mV to about 7 mV, about −6 mV to about 6 mV, about −5 mV to about 5 mV, about −4 mV to about 4 mV, about −3 mV to about 3 mV, about −2 mV to about 2 mV, about −1 mV to about 1 mV, less than, equal to, or greater than about −200 mV, −190, −185, −180, −175, −170, −165, −160, −155, −150, −145, −140, −135, −130, −125, −120, −115, −110, −105, −100, −95, −90, −85, −80, −75, −70, −65, −60, −55, −50, −45, −40, −35, −30, −29, −28, −27, −26, −25, −24, −23, −22, −21, −20, −19, −18, −17, −16, −15, −14, −13, −12, −11, −10, −9, −8, −7, −6, −5, −4, −3, −2, −1, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, or about 200 mV. Controlling the redox potential of the one or more emulsion polymers can be helpful to enhance the stability of the copper particles components and to minimize discoloration. In examples in which the coating composition includes one or more emulsion polymers, the polymers can independently have a weight-average molecular weight of at least about 15,000 Daltons, at least 50,000 Daltons, at least about 100,000 Daltons, at least about 500,000 Daltons, at least about 1,000,000 Daltons in a range of from about 25,000 Daltons to about 10,000,000 Daltons, about 60,000 Daltons to about 2,000,000 Daltons, about 100,000 Daltons to about 1,000,000 Daltons, less than, equal to, or greater than about 15,000 Daltons, 25,000, 50,000, 75,000, 100,000, 125,000, 150,000, 175,000, 200,000, 225,000, 250,000, 275,000, 300,000, 325,000, 350,000, 375,000, 400,000, 425,000, 450,000, 475,000, 500,000, 1,000,000, 2,000,000, 3,000,000, 4,000,000, 5,000,000, 6,000,000, 7,000,000, 8,000,000, 9,000,000, or about 10,000,000 Daltons.

According to various examples, the emulsion polymers can include one or more repeating units derived from monomers that can include a polymerizable phosphorous-containing monomer, an acetoacetoxy-functional acrylate, an acetoacetoxy-functional methacrylate, an acetoacetoxy-ethylmethacrylate, or a mixture thereof. Examples of suitable polymerizable phosphorous monomers include those having the structure according to Formula I, Formula II, or a mixture thereof:

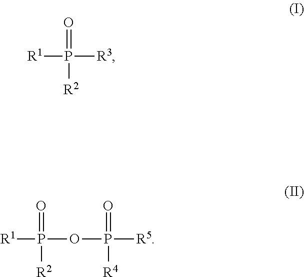

In either of Formula I or Formula II, R¹, R², R³, R⁴, and R⁵, can be independently selected from —H, —OH, and substituted or unsubstituted (C₁-C₂₀)hydrocarbyl, which can independently include at least one unsaturated polymerizable group. In further examples, R¹, R², R³, R⁴, and R⁵, are independently selected from —H, —OH, substituted or unsubstituted (C₁-C₂₀)alkyl, substituted or unsubstituted (C₁-C₂₀)alkenyl, substituted or unsubstituted (C₁-C₂₀)alkynyl, substituted or unsubstituted (C₁-C₂₀)alkoxy, substituted or unsubstituted (C₁-C₂₀)acyl, substituted or unsubstituted (C₁-C₂₀)cycloalkyl, substituted or unsubstituted (C₁-C₂₀)aryl, and mixtures thereof. Specific examples of polymerizable phosphorous-containing monomers can include a vinyl phosphonic acid monomer, an allyl phosphonic acid monomer, a 2-acrylamido-2-methylpropanephosphonic acid monomer, an α-phosphonostyrene monomer, a 2-methylacrylamido-2-methylpropanephosphonic acid monomer, a 1,2-ethylenically unsaturated (hydroxy)phosphinylalkyl (meth)acrylate monomer, a (hydroxy)phosphinylmethyl methacrylate, a dihydrogen phosphate monomer (e.g., monomers chosen from 2-phosphoethyl (meth)acrylate, 2-phosphopropyl (meth)acrylate, 3-phosphopropyl (meth)acrylate, and 3-phospho-2-hydroxypropyl (meth)acrylate), or mixtures thereof.

Acetoacetoxy-ethylmethacrylate monomers can be repeating units in an emulsion polymer. Phosphate acrylate monomer and acetoacetoxy-ethylmethacrylate can be a useful monomer in a polymer composition because it can scavenge copper ions and can further react with the copper ions to create a slow controlled release of copper ions from the inorganic glass comprising copper component. Moreover, the capture of copper by Acetoacetoxy-ethylmethacrylate can help to reduce color generation because of the pendant nature of Acetoacetoxy-ethylmethacrylate structure, which makes the copper releasable under certain conditions.

The coating composition can include a variety of initiators. The initiators can be water soluble and can include, for example, sodium persulfate (Na₂S₂O₈) and potassium persulfate (K₂S₂O₈); peroxides such as hydrogen peroxide and tert-butyl hydroperoxide (t-BHP); and azo compounds such as those available under the trade designation VAZO™ initiators, available from the Chemours Company, Wilmington, Del. The coating composition can further include an activator such as a bisulfite, a metabisulfite, ascorbic acid, erythorbic acid, sodium formaldehyde sulfoxylate, ferrous sulfate, ferrous ammonium sulfate, and ferric ethylenediamine tetraacetic acid.

According to some examples, the coating compositions described herein can be free of a chelator. The chelator can function to bind components of the coating composition, which can help to keep the components in solution or to prevent certain components from participating in undesired reactions. However, the chelator can also bind or complex with the copper thus rendering the copper unsuitable as a biocide. If a chelator is included, it can be important to carefully select certain chelators that either will not complex with the copper of the copper particles components or will not react to such an extent that the copper cannot function as a biocidal agent. An example of a suitable chelator that can be used or not, depending on the particular application, is ethylenediaminetetraacetic acid (EDTA).

According to various examples, the coating composition can include one or more pigments, which can include a pigment, a colorant or an extender. The colorants can give the coating composition its color, when for example, the coating composition is a paint composition. Where present, any of the pigment, extender, or the colorant can independently be in a range of from about 0.1 wt % to about 30 wt % of the coating composition, about 0.2 wt % to about 10 wt %, about 0.5 wt % to about 7 wt %, about 0.6 wt % to about 5 wt %, about 0.7 wt % to about 1 wt %, less than, equal to, or greater than about 0.1 wt %, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30 wt %. There are many suitable pigments, colorants, or extenders that can be included in the coating composition. For example, suitable extenders include rheological pigments, talc, aluminum trihydrate, barium sulfate, nepheline syenite, CaCO₃, silica, a flattening agent, zinc oxide, or a mixture thereof. An example of a pigment can include TiO₂. According to some examples, it can be desirable for the coating composition to be free of a colorant that includes manganese because manganese can react with copper and thus render copper unsatisfactory as a biocidal agent. According to various examples, the rheological pigments can serve as a pigment that can additionally promote additional desired properties in the coating composition. For example, rheological pigments include clays such as Attapulgite, a grade of clay, can be used as a rheological modifier that is capable of increasing viscosity of the coating composition. According to some examples, the clay can include hydrous aluminum phyllosilicate and in some examples iron, magnesium, alkali metals, alkaline earth metals, or mixtures thereof.

The coating compositions described herein can be formed according to any suitable method. For example, the coating compositions described herein can be formed by combining any combination or sub-combination of the components described herein, along with the biocidal dispersion, to form a coating composition precursor. The coating composition precursor can then be mixed at a low or high shear in an aqueous medium to form the coating composition. In further examples, all of the components of the coating composition, aside from the biocidal dispersion, can be present as a powder mixture. The powder mixture can be mixed and then water or an organic solvent can be added to disperse the components and form a liquid coating composition.

The coating composition can be dried to form a dried product. The dried product can be a film or layer having any desired thickness. Drying can be accomplished by simply exposing the coating composition to ambient conditions. In some examples, it can be desirable to expose the dried or even a semi-dried product to a secondary post-curing procedure. According to various examples, drying or a secondary post-curing procedure, can be accomplished, or aided, by exposing the coating composition to heat, reduced humidity or increased air flow or solar radiation.

In the final dried product, it can be desirable to have the inorganic glass comprising copper component heterogeneously distributed about the dried product. For example, it can be desirable to have a major portion of the inorganic glass comprising copper component located proximate to a surface of the dried product. For example, in a dried product, over 50 wt % of the copper particles components can be found between a plane defined by a surface of the dried product and a substantially parallel plane extending through the center of the dried product. For example, about 50 wt % to about 100 wt % of the copper particles components can be located proximate to the surface of the dried product, or about 55 wt % to about 95 wt %, about 60 wt % to about 90 wt %, about 65 wt % to about 85 wt %, about 70 wt % to about 80 wt %, less than, equal to, or greater than about 55 wt %, 60, 65, 70, 75, 80, 85, 90, 95, or about 100 wt %. Locating the major portion of the copper particles components proximate to the surface of the dried product can be desirable to increase the access of the copper to any microbes to which the dried product is exposed.

According to some examples, the dried product can further include a secondary coat of material substantially covering the dried product. The coat can be a secondary coat of a sealant material or a bottom primer coat. According to some examples, the coat covering the dried product can be substantially porous to allow copper released from the copper particles components to be released through the coat to an external environment. In further examples, the dried product can be a top coat that is applied over a surface or another product. In some examples, where the dried product is a top coat, the coating composition can be spray coated, brushed, roller coated, curtain coated, or a combination thereof, to the surface of the product to which it is coated.

The coating composition forming the dried product can be applied to a substrate. For example, if the coating composition is a paint, the coating composition can be applied to a substrate including wood, a plastic, a metal, a ceramic, a stone, cement, drywall. In some examples, a primer material can be applied to the substrate and the coating composition can be applied thereon. In some examples, the coating composition can be applied to a previously coated or weathered surface.

### WORKING EXAMPLES

Various examples of the present disclosure can be better understood by reference to the following Examples which are offered by way of illustration. The present disclosure is not limited to the Examples given herein.

### Working Example 1: Stability of Biocidal Dispersions Including Glass Comprising Copper and a Hydrophobically Modified Cellulose

The stability of a biocidal dispersion including a glass comprising copper available under the trade designation Guardiant™, available from Corning Incorporated, Corning, N.Y. and a hydrophobically modified cellulose available under the trade designation Natrosol plus 330 PA™, available from Ashland Specialty Chemical Company, Covington, Ky. was studied by varying the weight percentages of each component. Results are shown in Table 1, below. In Table 1, “Y” indicates a stable suspension (e.g., no sedimentation), “N” indicates an unstable suspension (e.g., sedimentation present), and “N/A” indicates that the mixture was not tested.

TABLE 1
Stability of compositions including Natrosol plus
330 PA ™ and Guardiant ™

| Guardiant ™ wt % | Natrosol plus 330 PA ™ wt % | Stable? |
|---|---|---|
| 10 | 0.3 | N |
| 10 | 1 | Y |
| 10 | 1.5 | Y |
| 10 | 3 | N |
| 15 | 0.3 | N |
| 15 | 1 | Y |
| 15 | 1.5 | Y |
| 17.5 | 1 | Y |
| 17.5 | 1.5 | Y |
| 20 | 0.3 | N |
| 20 | 0.75 | N |
| 20 | 1 | Y |
| 20 | 1.25 | N |
| 20 | 1.5 | N |
| 20 | 3 | N |
| 40 | 0.3 | N |
| 40 | 0.75 | N |
| 40 | 1 | N |
| 40 | 1.25 | N |
| 40 | 1.5 | N |

### Working Example 2: Determining the Minimum Bactericidal Concentration of Compositions Including Natrosol Plus 330 PA™ and Guardiant™

To determine the minimum bactericidal concentration of the biocidal dispersions, 1 g of compositions including Guardiant™ were obtained. Sample 1 included 10 wt % Guardiant™ and deionized water, Sample 2 included 10 wt % Guardiant™ and 1.5 wt % Natrosol plus 330 PA™. Sample 3 included 10 wt % Guardiant™ and 1 wt % Natrosol plus 330 PA™ (diluted to 50%). Sample 4 included 10 wt % Guardiant™ and 1 wt % Natrosol plus 330 PA™. Sample 5 was free of Guardiant™ but included 1.5 wt % Natrosol plus 330 PA™.

For each 1 g sample, 10 microcentrifuge tubes were prepared along with an additional blank tube. 900 μL of a Tryptic Soy broth was added to each tube (except the blank, which had 1000 μL of a broth). One of the 10 microcentrifuge tubes was vortexed and 100 μL of broth was removed and added to the second tube. This was repeated for the remaining microcentrifuge tubes (except for the blank) to make serial dilutions. 50 μL of Pseudomonas aeruginosa was added to each microcentrifuge tube (including the blank). The microcentrifuge tubes were incubated for 24 hours at 37° C. after which time 100 μL of each tube's contents were removed and plated. The plates were incubated for 24 hours at 37° C. after which time the plate were observed for colonies. The results are shown in Table 2. In Table 2, “−” indicates no bacterial recovery, “+” indicates trace contamination (<10 colonies), “++” indicates light contamination (<100 colonies), and “+++” indicates heavy contamination (continuous smear or growth).

TABLE 2
Minimal Bactericidal Concentration of compositions including Natrosol
plus 330 PA ™ and Guardiant ™

| | | Sample | Sample | Sample | Sample | Sample |
|---|---|---|---|---|---|---|
| Tube | Dilution | 1 | 2 | 3 | 4 | 5 |
| 1 | 1000000 | − | − | − | − | +++ |
| 2 | 10000 | ++ | − | +++ | − | +++ |
| 3 | 1000 | +++ | +++ | +++ | ++ | +++ |
| 4 | 100 | +++ | +++ | +++ | +++ | +++ |
| 5 | 10 | +++ | +++ | +++ | +++ | +++ |
| 6 | 1 | +++ | +++ | +++ | +++ | +++ |
| 7 | 0.1 | +++ | +++ | +++ | +++ | +++ |
| 8 | 0.01 | +++ | +++ | +++ | +++ | +++ |
| 9 | 0.001 | +++ | +++ | +++ | +++ | +++ |
| 10 | 0.0001 | +++ | +++ | +++ | +++ | +++ |
| 11 | Blank | +++ | +++ | +++ | +++ | +++ |

### Working Example 3: Stability of Biocidal Dispersions Including Glass Comprising Copper and a Cellulose

The stability of a biocidal dispersion including Guardiant™ and a cellulose available under the trade designation Natrosol 250 MHR™, available from Ashland Specialty Chemical Company, Covington, Ky. was studied by varying the weight percentages of each component. Results are shown in Table 3, below. In Table 3, “Y” indicates a stable suspension (e.g., no sedimentation), “N” indicates an unstable suspension (e.g., sedimentation present), and “N/A” indicates that the mixture was not tested.

TABLE 3
Stability of compositions including Natrosol 250
MHR ™ and Guardiant ™

| Guardiant ™ wt % | Natrosol 250 MHR ™ wt % | Stable? |
|---|---|---|
| 10 | 0.75 | N |
| 10 | 1 | Y |
| 10 | 1.5 | Y |
| 10 | 3 | N |
| 15 | 0.75 | N |
| 15 | 1 | Y |
| 15 | 1.5 | Y |
| 20 | 0.75 | Y |
| 20 | 1 | Y |
| 20 | 1.5 | Y |

### Working Example 4: Stability of Biocidal Dispersions Including Glass Comprising Copper and an Acrylic Acid

The stability of a biocidal dispersion including Guardiant™ and an alkali soluble emulsion available under the trade designation Acrysol ASE-60™, available from Dow Chemical, Midland Hills, Mich. was studied by varying the weight percentages of each component. A buffer was added to bring the pH to a desired value in a range of from about 3 to about 6. Results are shown in Table 4, below. In Table 4, “Y” indicates a stable suspension (e.g., no sedimentation) and “N” indicates an unstable suspension (e.g., sedimentation present.

TABLE 4
Stability of compositions including Natrosol 250 MHR ™ and
Acrysol ASE-60 ™

| pH | Acrysol 60 wt % | Guardiant ™ wt % | Stable? |
|---|---|---|---|
| 6.00 | 0.08 | 10 | N |
| 6.00 | 0.08 | 20 | N |
| 5.50 | 0.13 | 10 | N |
| 5.50 | 0.13 | 20 | N |
| 4.70 | 0.20 | 10 | N |
| 4.70 | 0.20 | 20 | N |
| 4.00 | 0.28 | 10 | N |
| 4.00 | 0.28 | 20 | N |
| 3.40 | 0.45 | 10 | Y |
| 3.40 | 0.45 | 20 | Y |

### Working Example 5: Determining the Minimum Bactericidal Concentration of Compositions Including Acrysol ASE-60™ and Guardiant™

To determine the minimum bactericidal a sample was prepared. The sample included 20 wt % Guardiant™ and Acrysol ASE-60™. For the sample, 10 microcentrifuge tubes were prepared along with an additional blank tube. 500 μL of a 1:500 DI water:Tryptic Soy Broth was added to each tube (except the blank, which had 500 μL of the broth). One of the 10 microcentrifuge tubes was vortexed and 100 μL of broth was removed and added to second tube. This was repeated for the remaining microcentrifuge tubes (except for the blank) to make serial dilutions. 50 μL of Pseudomonas aeruginosa was added to each microcentrifuge tube (including the blank). The microcentrifuge tubes were incubated for 24 hours at 37° C. after which time 100 μL of each tube's contents were removed and plated. The plates were incubated for 24 hours at 37° C. after which time the plate were observed for colonies. The results are shown in Table 5. In Table 5, “−” indicates no bacterial recovery, “+” indicates trace contamination (<10 colonies), “++” indicates light contamination (<100 colonies), and “+++” indicates heavy contamination (continuous smear or growth).

TABLE 5
Minimal Bactericidal Concentration of compositions including Natrosol
plus 330 PA ™ and Acrysol ASE-60 ™

| Tube | Dilution | Sample 1 |
|---|---|---|
| 1 | 1000000 | − |
| 2 | 10000 | − |
| 3 | 1000 | +++ |
| 4 | 100 | +++ |
| 5 | 10 | +++ |
| 6 | 1 | +++ |
| 7 | 0.1 | +++ |
| 8 | 0.01 | +++ |
| 9 | 0.001 | +++ |
| 10 | 0.0001 | +++ |
| 11 | Blank | +++ |

The terms and expressions that have been employed are used as terms of description and not of limitation, and there is no intention in the use of such terms and expressions of excluding any equivalents of the features shown and described or portions thereof, but it is recognized that various modifications are possible within the scope of the examples of the present disclosure. Thus, it should be understood that although the present disclosure has been specifically disclosed by specific examples and optional features, modification and variation of the concepts herein disclosed can be resorted to by those of ordinary skill in the art, and that such modifications and variations are considered to be within the scope of examples of the present disclosure.

### Additional Examples

The following exemplary examples are provided, the numbering of which is not to be construed as designating levels of importance:

Example 1 provides a biocidal dispersion comprising:

one or more inorganic glass comprising copper particles; and

a dispersant, a thickener, or a mixture thereof,

wherein the inorganic glass comprising copper is homogenously distributed about the biocidal dispersion and is in a range of from about 3 wt % to about 88 wt % of the biocidal dispersion.

Example 2 provides the biocidal dispersion of Example 1, wherein the one or more inorganic glass comprising copper particles are in a range of from about 42 wt % to about 85 wt % of the biocidal dispersion.

Example 3 provides the biocidal dispersion of Example 2, wherein one or more inorganic glass comprising copper particles are in a range of from about 10 wt % to about 22 wt % of the biocidal dispersion.

Example 4 provides the biocidal dispersion of any one of Examples 1-3, wherein a median size of the one or more inorganic glass comprising copper particles are in a range of from about 1 μm to about 15 μm.

Example 5 provides the biocidal dispersion of any one of Examples 1-4, wherein a median size of the one or more inorganic glass comprising copper particles are in a range of from about 3 μm to about 8 μm.

Example 6 provides the biocidal dispersion of any one of Examples 1-5, wherein the one or more inorganic glass comprising copper particles independently comprise an inorganic glass comprising SiO₂, Al₂O₃, CaO, MgO, P₂O₅, B₂O₃, K₂O, ZnO, Fe₂O₃, or a mixture thereof.

Example 7 provides the biocidal dispersion of any one of Examples 1-6, wherein the one or more inorganic glass comprising copper particles independently comprise an inorganic glass comprising SiO₂ nanoparticles, alumina nanoparticles, or mixtures thereof.

Example 8 provides the biocidal dispersion of any one of Examples 1-7, wherein the copper is independently in a range of from about 25 wt % to about 40 wt % of the one or more inorganic glass comprising copper particles.

Example 9 provides the biocidal dispersion of any one of Examples 1-8, wherein the copper is independently Cu metal, Cu⁺, Cu²⁺, or a combination of Cu⁺ and Cu²⁺.

Example 10 provides the biocidal dispersion of any one of Examples 1-9, wherein the dispersant, the thickener, or mixture thereof, comprises an organic solution or an aqueous solution.

Example 11 provides the biocidal dispersion of any one of Examples 1-10, wherein the dispersant, the thickener, or mixture thereof, comprises cellulose, an acrylic acid containing polymer, a urethane, or a mixture thereof.

Example 12 provides the biocidal dispersion of any one of Examples 1-11, wherein the thickener comprises hydroxyethyl cellulose, methyl cellulose, carboxymethyl cellulose, or a mixture thereof.

Example 13 provides the biocidal dispersion of any one of Examples 1-12, further comprising a pH modifier.

Example 14 provides the biocidal dispersion of Example 13, wherein a pKa of the pH modifier is in a range of from about 4.7 to about 14.

Example 15 provides the biocidal dispersion of any one of Examples 13 or 14, wherein a pKa of the pH modifier is in a range of from about 7 to about 9.

Example 16 provides the biocidal dispersion of any one of Examples 13-15, wherein the pH modifier is in a range of from about 0.01 wt % to about 5 wt % of the biocidal dispersion.

Example 17 provides the biocidal dispersion of any one of Examples 13-16, wherein the pH modifier is in a range of from about 0.1 wt % to about 1.3 wt % of the biocidal dispersion.

Example 18 provides the biocidal dispersion of any one of Examples 13-17, wherein the pH modifier is selected from the group consisting of Group (I) hydroxides; Group (II) hydroxides; and organic amines.

Example 19 provides the biocidal dispersion of any one of Examples 13-18, wherein the pH modifier is selected from metal hydroxides, ammonium hydroxide, and amines, wherein the amines are amines of the formula NH₂R, wherein R is selected from the group consisting of H, OR′ or —R′—OH, wherein R′ is selected from the group consisting of H, alkane, and alkylene.

Example 20 provides the biocidal dispersion of any one of Examples 13-19, wherein the pH modifier comprises potassium hydroxide, sodium hydroxide, 2-amino-2methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine, or a mixture thereof.

Example 21 provides the biocidal dispersion of any one of Examples 13-20, wherein the pH modifier comprises a mixture of at least one of potassium hydroxide and sodium hydroxide and at least one of 2-amino-2methyl-1-propanol and ammonium, wherein at least one of potassium hydroxide and sodium hydroxide, or a mixture thereof are the major component of the pH modifier mixture.

Example 22 provides the biocidal dispersion of any one of Examples 1-21, wherein the biocidal dispersion further comprises a solvent.

Example 23 provides the biocidal dispersion of Example 22, wherein the solvent is an aqueous solvent or an organic solvent.

Example 24 provides the biocidal dispersion of Example 23, wherein the organic solvent comprises isopropanol, xylene, butyl acetate, or a mixture thereof.

Example 25 provides the biocidal dispersion of any one of Examples 1-24, further comprising a surfactant.

Example 26 provides the biocidal dispersion of Example 25, wherein the surfactant is in a range of from about 0.5 wt % to about 40 wt % of the biocidal dispersion.

Example 27 provides the biocidal dispersion of any one of Examples 25 or 26, wherein the surfactant is in a range of from about 1 wt % to about 10 wt % of the biocidal dispersion.

Example 28 provides the biocidal dispersion of any one of Examples 1-27, further comprising a defoamer or air release agent.

Example 29 provides the biocidal dispersion of Example 28, wherein the defoamer or air release agent is in a range of from about 0.5 wt % to about 40 wt % of the biocidal dispersion.

Example 30 provides the biocidal dispersion of any one of Examples 28 or 29, wherein the defoamer or air release agent is in a range of from about 1 wt % to about 10 wt % of the biocidal dispersion.

Example 31 provides the biocidal dispersion of any one of Examples 1-30, further comprising a clay, silica, or a mixture thereof.

Example 32 provides the biocidal dispersion of Example 31, wherein the clay comprises, attapulgite, laponite, bentonite, or a mixture thereof and the silica comprises a fumed silica.

Example 33 provides the biocidal dispersion of Example 31 or 32, wherein the clay, silica, or mixture thereof is in a range of from about 0.5 wt % to about 40 wt % of the biocidal dispersion.

Example 34 provides the biocidal dispersion of any one of Examples 31-33, wherein the clay is in a range of from about 1 wt % to about 10 wt % of the biocidal dispersion.

Example 35 provides the biocidal dispersion of any one of Examples 1-34, further comprising a stabilizer.

Example 36 provides the biocidal dispersion of Example 35, wherein the stabilizer comprises an organophosphate, an ammonium phosphate, a potassium tripolyphosphate, or a mixture thereof.

Example 37 provides the biocidal dispersion of any one of Examples 35 or 36, wherein the defoamer or air release agent is in a range of from about 0.5 wt % to about 40 wt % of the biocidal dispersion.

Example 38 provides the biocidal dispersion of any one of Examples 35-37, wherein the defoamer or air release agent is in a range of from about 1 wt % to about 10 wt % of the biocidal dispersion.

Example 39 provides the biocidal dispersion of any one of Examples 1-38, further comprising a rheology modifier.

Example 40 provides the biocidal dispersion of Example 39, wherein the rheology modifier is in a range of from about 0.5 wt % to about 40 wt % of the biocidal dispersion.

Example 41 provides the biocidal dispersion of any one of Examples 39 or 40, wherein the rheology modifier is in a range of from about 1 wt % to about 10 wt % of the biocidal dispersion.

Example 42 provides a coating composition comprising:

the biocidal dispersion of any one of Examples 1-41;

one or more emulsion polymers;

a second pH modifier; and

a second organic solvent or a second aqueous solvent.

Example 43 provides the coating composition of Example 42, wherein the one or more emulsion polymers have a weight-average molecular weight of at least 15,000 Daltons.

Example 44 provides the coating composition of any one of Examples 42 or 43, wherein the one or more emulsion polymers have a weight-average molecular weight of at least 1,000,000 Daltons.

Example 45 provides the coating composition of any one of Examples 42-44, wherein the one or more emulsion polymers have a weight-average molecular weight in a range of from about 15,000 Daltons to about 5,000,000 Daltons.

Example 46 provides the coating composition of any one of Examples 42-45, wherein the one or more emulsion polymers have a weight-average molecular weight in a range of from about 100,000 Daltons to about 1,000,000 Daltons.

Example 47 provides the coating composition of any one of Examples 42-46, wherein one or more emulsion polymers include a repeating unit derived from a polymerizable phosphorous-containing monomer, an acetoacetoxy-functional acrylate, an acetoacetoxy-functional methacrylate, an acetoacetoxy-ethylmethacrylate, or a mixture thereof.

Example 48 provides the coating composition of Example 47, wherein the polymerizable phosphorous monomer comprises the structure according to Formula I, Formula II, or a mixture thereof:

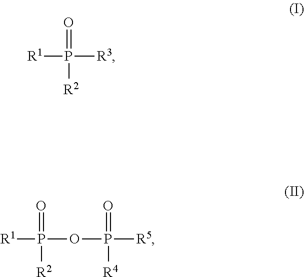

wherein R¹, R², R³, R⁴, and R⁵, are independently selected from —H, —OH, and substituted or unsubstituted (C₁-C₂₀)hydrocarbyl comprising at least one unsaturation R¹, R², R³, R⁴, and R⁵ is a polymerizable group.

Example 49 provides the coating composition of Example 48, wherein R¹, R², R³, R⁴, and R⁵, are independently selected from —H, —OH, substituted or unsubstituted (C₁-C₂₀)alkyl, substituted or unsubstituted (C₁-C₂₀)alkenyl, substituted or unsubstituted (C₁-C₂₀)alkynyl, substituted or unsubstituted (C₁-C₂₀)alkoxy, substituted or unsubstituted (C₁-C₂₀)acyl, substituted or unsubstituted (C₁-C₂₀)cycloalkyl, substituted or unsubstituted (C₁-C₂₀)aryl, and mixtures thereof.

Example 50 provides the coating composition of any one of Examples 42-49, wherein the one or more inorganic glass comprising copper particles are in a range of from about 0.5 wt % to about 25 wt % of the coating composition.

Example 51 provides the coating composition of Example 50, wherein one or more inorganic glass comprising copper particles are in a range of from about 1 wt % to about 5 wt % of the coating composition.

Example 52 provides the coating composition of any one of Examples 50 or 51, wherein the second pH modifier of the biocidal dispersion is the same pH modifier as the coating composition of any one of Examples 42-51.

Example 53 provides the coating composition of any one of Examples 42-52, wherein a pKa of the second pH modifier is in a range of from about 4.7 to about 14.

Example 54 provides the coating composition of any one of Examples 42-53, wherein a pKa of the second pH modifier is in a range of from about 7 to about 9.

Example 55 provides the coating composition of any one of Examples 42-54, wherein the second pH modifier is in a range of from about 0.1 wt % to about 5 wt % of the coating composition.

Example 56 provides the coating composition of any one of Examples 42-55, wherein the second pH modifier is in a range of from about 0.1 wt % to about 1.3 wt % of the coating composition.

Example 57 provides the coating composition of any one of Examples 42-56, wherein the second pH modifier is selected from the group consisting of Group (I) hydroxides; Group (II) hydroxides; and organic amines.

Example 58 provides the coating composition of any one of Examples 42-57, wherein the second pH modifier is selected from metal hydroxides, ammonium hydroxide, and amines, wherein the amines are amines of the formula NH₂R″, wherein R″ is selected from the group consisting of H, OR′″ or —R′″—OH, wherein R′″ is selected from the group consisting of H, alkane, and alkylene.

Example 59 provides the coating composition of any one of Examples 42-58, wherein the second pH modifier comprises potassium hydroxide, sodium hydroxide, 2-amino-2methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine, or a mixture thereof.

Example 60 provides the coating composition of any one of Examples 42-59, wherein the second pH modifier comprises a mixture of at least one of potassium hydroxide and sodium hydroxide and at least one of 2-amino-2methyl-1-propanol and ammonium, wherein at least one of potassium hydroxide and sodium hydroxide, or a mixture thereof are the major component of the pH modifier mixture.

Example 61 provides the coating composition of any one of Examples 42-60, further comprising at least one colorant.

Example 62 provides the coating composition of Example 61, wherein the colorant is in a range of from about 0.1 wt % to about 22 wt % of the coating composition.

Example 63 provides the coating composition of any one of Examples 61 or 62, wherein the colorant is in a range of from about 1 wt % to about 5 wt % of the coating composition.

Example 64 provides the coating composition of any one of Examples 42-63, further comprising at least one extender.

Example 65 provides the coating composition of Example 64, wherein the extender is in a range of from about 0.1 wt % to about 15 wt % of the coating composition.

Example 66 provides the coating composition of any one of Examples 64 or 65, wherein the extender is in a range of from about 1 wt % to about 5 wt % of the coating composition.

Example 67 provides the coating composition of any one of Examples 42-66, wherein the pigment or extender comprises clay, talc, TiO₂, aluminum trihydrate, nepheline syenite, CaCO₃, silica, a flattening agent, barium sulfate, zinc oxide, or a mixture thereof.

Example 68 provides the coating composition of any one of Examples 42-67, further comprising at least one pigment.

Example 69 provides the coating composition of Example 68, wherein the pigment is in a range of from about 0.1 wt % to about 30 wt % of the coating composition.

Example 70 provides the coating composition of any one of Examples 68 or 69, wherein the pigment is in a range of from about 1 wt % to about 5 wt % of the coating composition.

Example 71 provides the coating composition of any one of Examples 68-70, wherein the pigment is TiO₂.

Example 72 provides the coating composition of any one of Examples 42-71, further comprising a second defoamer or air release agent.

Example 73 provides the coating composition of Example 72, wherein the second defoamer or air release agent is free of a silicone.

Example 74 provides the coating composition of any one of Examples 31-71, wherein the second defoamer or air release agent is the same as the defoamer or air release agent of any one of Examples 72 or 73.

Example 75 provides the coating composition of any one of Examples 42-74, further comprising a second rheology modifier.

Example 76 provides the coating composition of Example 75, wherein the second rheology modifier is in a range of from about 0.1 wt % to about 5 wt % of the coating composition.

Example 77 provides the coating composition of any one of Examples 75 or 76, wherein the second rheology modifier is in a range of from about 1 wt % to about 4 wt % of the coating composition.

Example 78 provides the coating composition of any one of Examples 75-77, wherein the second rheology modifier is a thickener comprising hydroxyethyl cellulose, methyl cellulose, carboxymethyl cellulose, hydroxyethylcellulose, hydrophobically modified, an alkali swellable emulsion, a hydrophobically modified ethoxylated urethane, hydrophobically modified analogues thereof, a natural or synthetic gum thereof, or a mixture thereof.

Example 79 provides the coating composition of any one of Examples 42-78, wherein a viscosity of the coating composition is in a range of from about 70 KU to about 130 KU.

Example 80 provides the coating composition of any one of Examples 42-79, wherein a viscosity of the coating composition is in a range of from about 80 KU to about 115 KU.

Example 81 provides the coating composition of any one of Examples 42-80, wherein a pH of the coating composition is in a range of from about 6 to about 9.5.

Example 82 provides the coating composition of any one of Examples 42-81, wherein a pH of the coating composition is in a range of from about 7.5 to about 9.

Example 83 provides the coating composition of any one of Examples 42-82, wherein the coating composition is a paint, an elastomeric coating, a caulk, a sealant, a floor polish, a fabric treatment, a secondary coat, or a primer.

Example 84 provides the coating composition of any one of Examples 42-83, wherein the coating composition is configured to kill a microbe chosen from Staphylococcus aureus, Enterobacter aerogenes, Pseudomonas aeruginosa, Methicillin Resistant Staphylococcus aureus, E. coli, and mixtures thereof.

Example 85 provides the coating composition of any one of Examples 42-84, wherein a log reduction of the coating composition is at least about 2.

Example 86 provides the coating composition of any one of Examples 42-85, wherein the log reduction of the coating composition is at least 3.

Example 87 provides the coating composition of any one of Examples 42-86, wherein a CIEL*a*b* delta E* of the coating composition is less than about 30.

Example 88 provides the coating composition of any one of Examples 42-87, wherein a CIEL*a*b* delta E* of the coating composition is less than about 6.

Example 89 provides the coating composition of any one of Examples 42-88, wherein the coating composition is free of a sediment of the glass comprising copper.

Example 90 provides the coating composition of any one of Examples 42-89, wherein the coating composition is free of a sediment of the glass comprising copper for a time period in a range of from about 1 day to about 365 days.

Example 91 provides the coating composition of any one of Examples 42-90, wherein the coating composition is free of a sediment of the glass comprising copper for a time period in a range of from about 5 days to about 90 days.

Example 92 provides a method of making the biocidal dispersion of any one of Examples 1-91, the method comprising:

combining the one or more inorganic glass comprising copper particles and dispersant, the thickener, or mixture thereof, to form a dispersion precursor; and

mixing the dispersion precursor to form the biocidal dispersion.

Example 93 provides a method of making the coating composition of any one of Examples 42-92, the method comprising:

combining the biocidal dispersion of any one of Examples 1-41, with the one or more emulsion polymers, the second pH modifier, and second organic solvent or second aqueous solvent.

Example 94 provides a dried product of the coating composition of any one of Examples 42-93.

Example 95 provides the dried product of Example 94, further comprising a secondary coat at least partially covering the dried product.

Example 96 provides the dried product of Example 95, wherein the secondary coat is porous.

Example 97 provides an assembly comprising:

a substrate; and

the coating composition of any one of Examples 42-93 or the dried product of any one of Examples 94 or 95.

Example 98 provides the assembly of Example 97, wherein the substrate comprises wood, a plastic, a metal, a ceramic, a stone, cement, drywall, fiberboard, paint, or a mixture thereof.

Example 99 provides a method of making the assembly of any one of Examples 97 or 98, the method comprising:

applying the coating composition to at least a portion of the substrate; and

drying the composition thereon.

Example 100 provides the method of Example 99, wherein the coating composition is applied to the substrate by brush, spray coating, roller coating, curtain coating, or a combination thereof.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some examples, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some examples, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some examples, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some examples, the cycloalkyl group can have 3 to about 8-12 ring members, whereas in other examples the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some examples, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain examples there is no hydrocarbyl group.

The term “weight-average molecular weight” as used herein refers to which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, gel permeation chromatography, and sedimentation velocity.

The polymers described herein can terminate in any suitable way. In some examples, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

1. A biocidal dispersion comprising:
one or more copper particles components homogenously distributed about the biocidal dispersion; and
a dispersant, a thickener, or a mixture thereof,
wherein the copper particles components comprise from about 3 wt % to about 88 wt % of the biocidal dispersion.

2. The biocidal dispersion of claim 1, wherein the one or more copper particles components comprise one or more inorganic glass comprising copper particles.

3. The biocidal dispersion of claim 2, wherein the one or more inorganic glass comprising copper particles comprise from about 20 wt % to about 65 wt % of the biocidal dispersion.

4. The biocidal dispersion of claim 2, wherein a median size of the one or more inorganic glass comprising copper particles is in a range of from about 1 μm to about 15 μm.

5. The biocidal dispersion of claim 2, wherein the one or more inorganic glass comprising copper particles independently comprise an inorganic glass comprising SiO₂, Al₂O₃, CaO, MgO, P₂O₅, B₂O₃, K₂O, ZnO, Fe₂O₃, or a mixture thereof.

6. The biocidal dispersion of claim 1, wherein the dispersant, the thickener, or mixture thereof, comprises an organic solution or an aqueous solution.

7. The biocidal dispersion of claim 1, wherein the dispersant, the thickener, or mixture thereof, comprises cellulose, an acrylic acid containing polymer, a urethane, or a mixture thereof.

8. The biocidal dispersion of claim 1, comprising the thickener, wherein the thickener comprises hydroxyethyl cellulose, methyl cellulose, carboxymethyl cellulose, or a mixture thereof.

9. The biocidal dispersion of claim 1, further comprising a pH modifier, wherein a pKa of the pH modifier is in a range of from about 4.7 to about 14.

10. (canceled)

11. A coating composition comprising:
the biocidal dispersion of claim 1;
one or more emulsion polymers;
a second pH modifier; and
a second organic solvent or a second aqueous solvent.

12. The coating composition of claim 11, wherein the one or more emulsion polymers have a weight-average molecular weight of at least 15,000 Daltons.

13. The coating composition of claim 11, wherein a viscosity of the coating composition is in a range of from about 70 KU to about 130 KU.

14. The coating composition of claim 11, wherein a pH of the coating composition is in a range of from about 6 to about 9.5.

15. The coating composition of claim 11, wherein the coating composition is configured to kill a microbe chosen from a bacteria, a virus, a fungi, or a mixture thereof.

16. The coating composition of claim 11, wherein a log reduction of the coating composition is at least about 2.

17. The coating composition of claim 11, wherein a CIEL*a*b* delta E* of the coating composition is less than about 15.

18. A method of making the biocidal dispersion of claim 1, the method comprising:
combining the one or more copper particles components and the dispersant, thickener, or a mixture thereof, to form a dispersion precursor; and
mixing the dispersion precursor to form the biocidal dispersion.

19. A method of making a coating composition, the method comprising:
combining the biocidal dispersion of claim 1, with one or more emulsion polymers, a second pH modifier, and a second organic solvent or a second aqueous solvent to form a coating composition precursor; and
mixing the coating composition precursor in an aqueous medium to form the coating composition.

20. A dried product of the coating composition of claim 11.

21. The dried product of claim 20, further comprising a secondary coat at least partially covering the dried product, wherein the secondary coat is substantially porous to allow copper released from the copper particles components to be released through the secondary coat to an external environment.

22. (canceled)
